(19) United States
(12) Patent Application Publication
(10) Pub. No.: US 2016/0326948 A1
(43) Pub. Date: Nov. 10, 2016

(54) INTAKE AIR COOLING DEVICE OF INTERNAL COMBUSTION ENGINE

(71) Applicant: MAZDA MOTOR CORPORATION, Hiroshima (JP)

(72) Inventor: Eiji TAKANO, Hiroshima-shi (JP)

(73) Assignee: MAZDA MOTOR CORPORATION, Hiroshima (JP)

(21) Appl. No.: 15/144,085

(22) Filed: May 2, 2016

(30) Foreign Application Priority Data
May 8, 2015 (JP) 2015-095841

(51) Int. Cl. F02B 29/04

(52) U.S. Cl. CPC F02B 29/0437; F02B 29/0462

(57) ABSTRACT

An intake air cooling device includes an intake manifold with a housing and a plurality of individual intake pipes, a water cooling intercooler housed in the housing and a common intake pipe configured to introduce air into the housing. The housing has a first surface and a second surface facing each other. In the housing, the intercooler is housed in a space near the first surface and a communication space is formed between the second surface and the intercooler. The common intake pipe and the individual intake pipes are arranged side by side on the side of the first surface. The housing forms such an intake passage that air introduced from the common intake pipe reaches the communication space after passing through the first part of the intercooler and is introduced into the individual intake pipes after passing from the communication space to the second part of the intercooler.

### CROSS REFERENCE TO RELATED APPLICATIONS

This application is based on Japanese Patent Application No. 2015-095841 filed with the Japan Patent Office on May 8, 2015, the contents of which are hereby incorporated by reference.

### TECHNICAL FIELD

The present invention relates to an intake air cooling device of an internal combustion engine and particularly to an improvement of the arrangement of an intercooler which is a cooling device for intake air.

### BACKGROUND

In an internal combustion engine, as an intake temperature decreases, an intake density and, consequently, an intake mass increase, more fuel can be burned and an output is improved. Thus, an intercooler for cooling intake air is arranged in an intake passage particularly in an engine with a supercharger.

For example, Japanese Unexamined Patent Publication No. 2001-248448 discloses an intake air cooling device of an internal combustion engine in which a cooling core by high-temperature cooling water is arranged upstream of a collecting part of an intake manifold and a cooling core by low-temperature cooling water is arranged downstream thereof. A high-temperature cooling water system in which the high-temperature cooling water for cooling a cylinder block and a cylinder head of the engine is circulated is connected to the former high-temperature core. A low-temperature cooling water system which is different from the high-temperature cooling water system and in which the low-temperature cooling water cooled by a heat exchanger is circulated by a cooling water pump is connected to the latter low-temperature core. The intake air cooling device efficiently cools the intake air in two stages by these high-temperature and low-temperature cores.

However, in the above intake air cooling device, the upstream cooling core in which the high-temperature cooling water flows and the downstream cooling core in which the low-temperature cooling water flows are arranged in a vertical direction of the collecting part of the intake manifold. Thus, in the case of a vehicle with a low hood, it is difficult to arrange the both cooling cores in an engine compartment, which may obstruct compact installation of pipes of the high-temperature cooling water system and the low-temperature cooling water system.

### SUMMARY

An object of the present invention is to enhance intake air cooling efficiency while compactly arranging an intercooler in an intake air cooling device of an internal combustion engine having the intercooler arranged in an intake passage.

An intake air cooling device of an internal combustion engine according to one aspect of the present invention achieving this object is an intake air cooling device of a multi-cylinder internal combustion engine and includes an intake manifold with a housing defining a space extending in a cylinder row direction of multiple cylinders and a plurality of individual intake pipes projecting from the housing and communicating with the respective cylinders, a water cooling intercooler housed in the housing, and a common intake pipe coupled to the housing and configured to introduce air into the housing.

The housing has a first surface and a second surface facing each other. The water cooling intercooler is housed in a space near the first surface in the housing and a communication space extending in the cylinder row direction is formed between the second surface and the water cooling intercooler. The common intake pipe and the individual intake pipes are arranged side by side on the side of the first surface of the housing. The water cooling intercooler includes a first part facing the common intake pipe and a second part facing the individual intake pipes.

The housing forms such an intake passage that the air introduced from the common intake pipe reaches the communication space after passing through the first part and is introduced into the individual intake pipes after passing from the communication space to the second part.

### BRIEF DESCRIPTION OF DRAWINGS

FIG. 1 is a perspective view of an intake air cooling device of an internal combustion engine according to a first embodiment of the present invention,

FIG. 2 is a plan view partly in section of the intake air cooling device and a configuration diagram of a cooling water circulation device,

FIG. 3 is a front view of a plate single body of an intercooler used in the first embodiment,

FIG. 4 is a front view of the intake air cooling device,

FIG. 5 is a bottom view of the intake air cooling device,

FIG. 6 is a sectional view taken along line VI-VI of FIG. 2,

FIG. 7 is a sectional view taken along line VII-VII of FIG. 3,

FIG. 8 is a front view of an intake air cooling device according to a second embodiment of the present invention,

FIGS. 9A and 9B are respectively front views of single bodies of a downstream plate and an upstream plate of an intercooler used in the second embodiment, and

FIG. 10 is a configuration diagram of a downstream cooling water circulation device and an upstream cooling water circulation device according to a third embodiment of the present invention.

### DETAILED DESCRIPTION

Hereinafter, embodiments of the present invention are described with reference to the accompanying drawings.

### First Embodiment

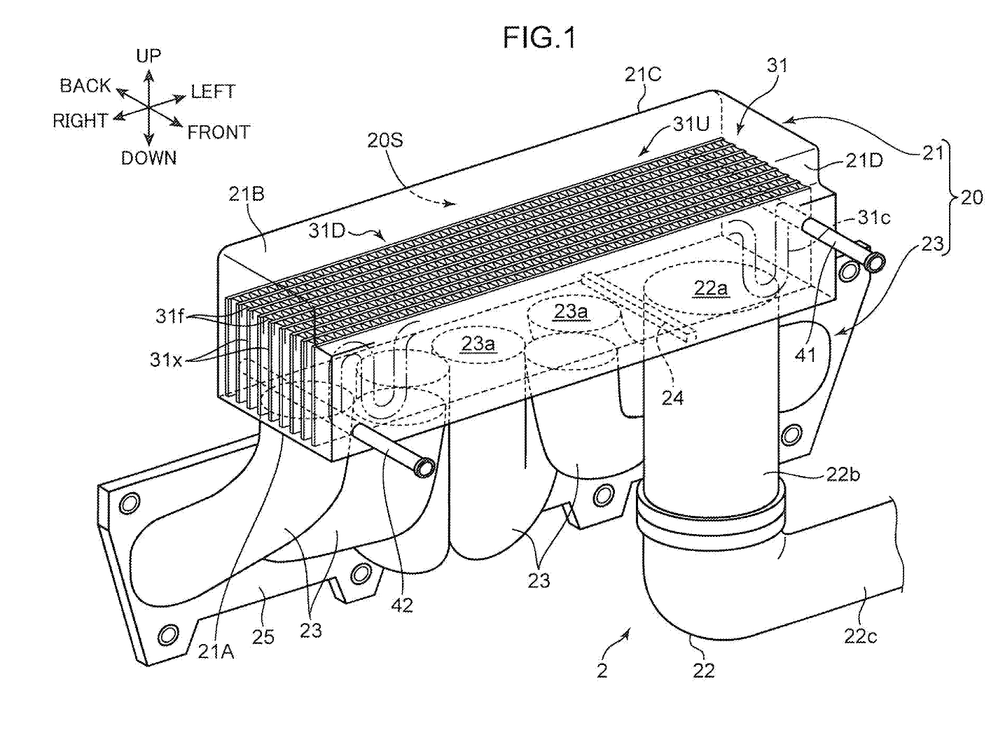

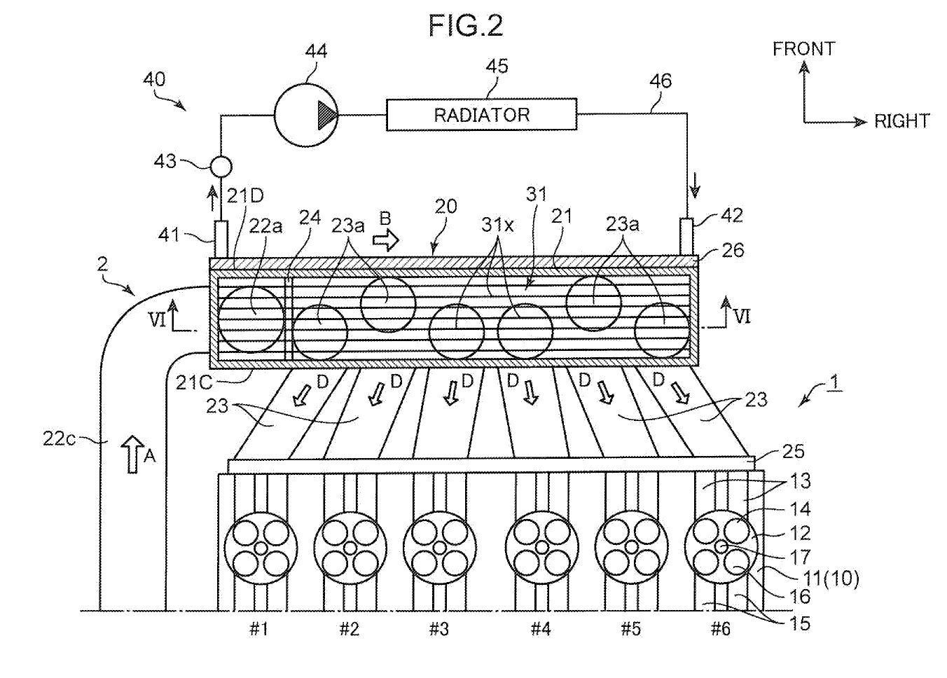

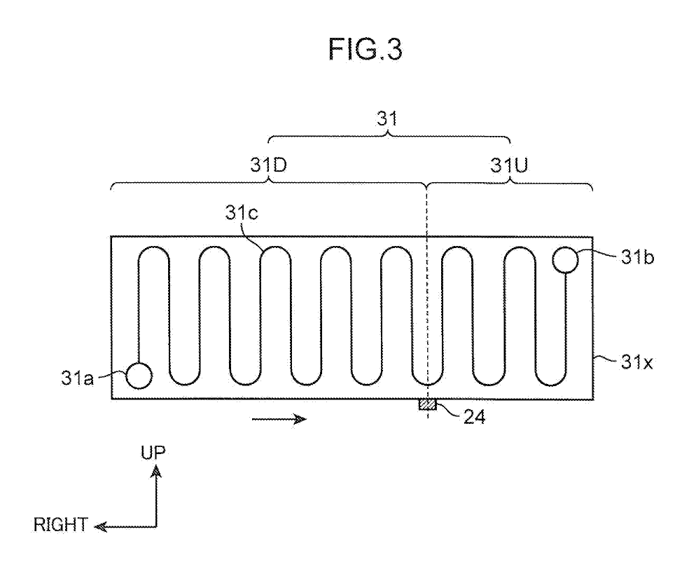

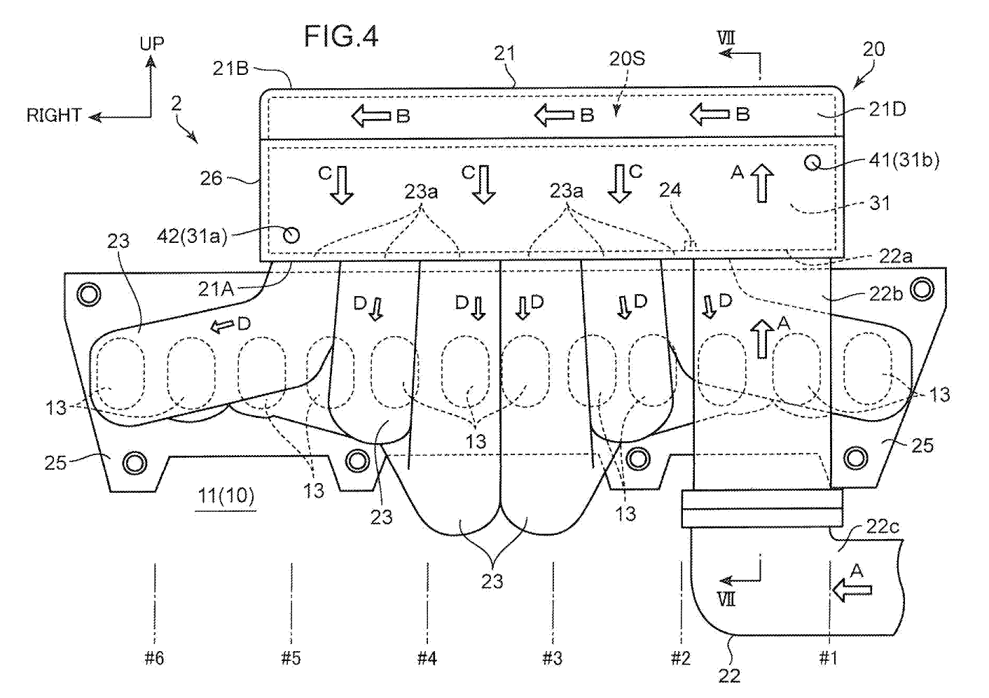

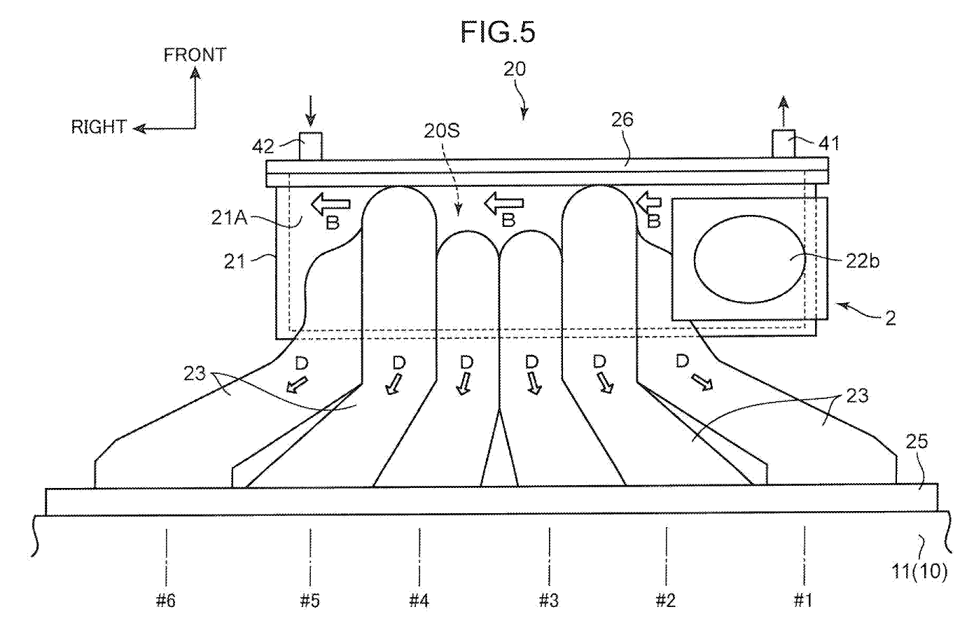

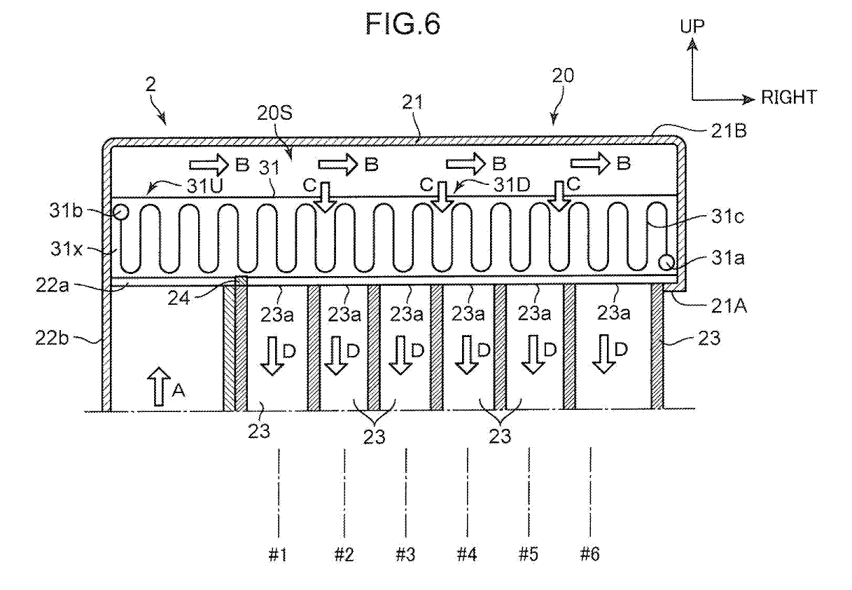

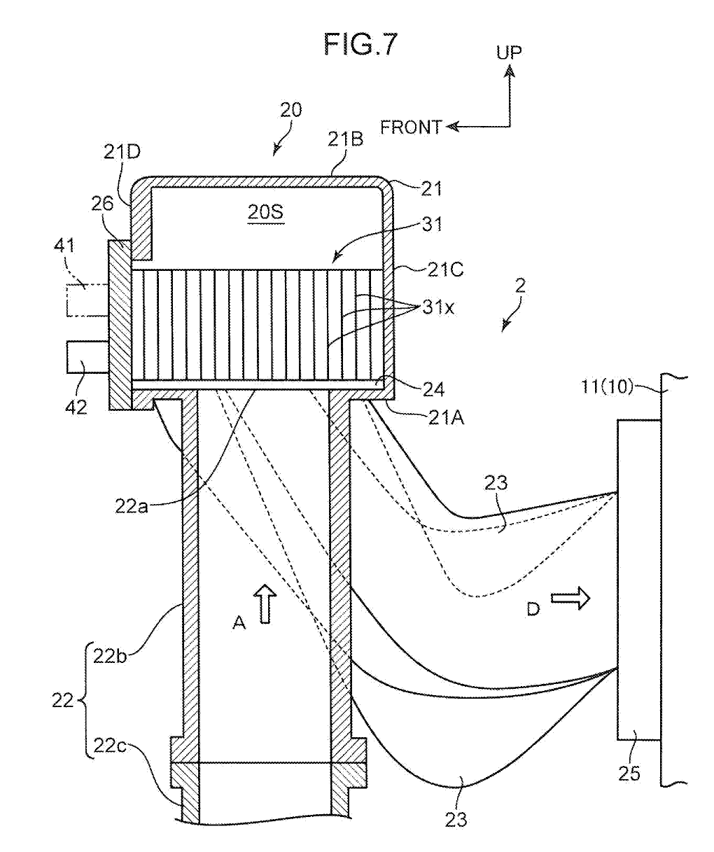

FIG. 1 is a perspective view of an intake air cooling device of an internal combustion engine according to a first embodiment of the present invention. FIG. 2 is a plan view partly in section of the intake air cooling device and a configuration diagram of a cooling water circulation device. FIG. 3 is a view of a plate single body of an intercooler used in the first embodiment. FIGS. 4 and 5 are a front view and a bottom view of the intake air cooling device. FIGS. 6 and 7 are a sectional view taken along line VI-VI of FIG. 2 and a sectional view taken along line VII-VII of FIG. 3.

As shown in FIG. 1, the intake air cooling device is a cooling device provided in an intake passage 2 of a multi-cylinder engine (internal combustion engine) and includes an intake manifold 20 with a housing 21 and a plurality of independent intake pipes 23, a water cooling system intercooler 31 housed in the housing 21 and a common intake pipe 22 coupled to the housing 21 and configured to introduce air into the housing 21. The housing 21 of the intake manifold 20 defines a space extending in a cylinder row direction (lateral direction in this embodiment) of multiple cylinders. The plurality of independent intake pipes 23 are independent air passages projecting from the housing 21 and communicating with the respective cylinders.

As shown in FIG. 2, an engine 1 according to this embodiment is an inline six-cylinder, 4-cycle gasoline engine mounted in a vehicle such as an automotive vehicle and equipped with an unillustrated supercharger for supercharging intake air. An engine main body 10 includes a cylinder head 11 and an unillustrated cylinder block and is horizontally mounted such that the cylinder row direction faces in a vehicle width direction (lateral direction) in an engine compartment of a vehicle front part. Each cylinder 12 includes two intake ports 13 and two intake valves 14, two exhaust ports 15 and two exhaust valves 16, an unillustrated fuel injection valve and one spark plug 17. Six cylinders 12 are successively called a first cylinder #1, a second cylinder #2, a third cylinder #3, a fourth cylinder #4, a fifth cylinder #5 and a sixth cylinder #6 from left to right of the vehicle.

The intake passage 2 is for supplying the intake air to these cylinders 12 and arranged on a vehicle front side of the engine main body 10. The intake passage 2 in this embodiment includes a common intake pipe 22, the housing 21 and the individual intake pipes 23 successively from an upstream side of an air flow. A space defined by the housing 21 is a space serving as a collecting part (collector) for collecting upstream ends of the plurality of individual intake pipes 23 and connecting them to the one common intake pipe 22. A mounting flange 25 is attached to a downstream end side of the intake manifold 20. The intake manifold 20 is mounted on the front side surface of the cylinder head 11 via the mounting flange 25.

As shown in FIGS. 1 and 4 to 7, the intake manifold 20 has a communication space 20S of a predetermined capacity extending in the cylinder row direction. Specifically, the box-shaped housing 21 is arranged to extend in the cylinder row direction before the cylinder head 11 and a part (upper part) of the space of the collecting part of the housing 21 serves as the communication pace 20S.

The housing 21 is a substantially rectangular parallelepipedic housing whose longitudinal direction is aligned with the cylinder row direction, and has a bottom surface 21A and an upper surface 21B (first and second surfaces facing each other) defining the space of the aforementioned collecting part, a rear side surface 21C (first side surface) facing the engine 1 and a front side surface 21D opposite to the rear side surface 21C. The common intake pipe 22 and the individual intake pipes 23 are arranged side by side on the side of the lower surface 21A of the housing 21. In the housing 21, the intercooler 31 is housed in a space close to the lower surface 21A out of the collecting part space, and a space where no component is housed is present near the upper surface 21B. This space, i.e. a space extending in the cylinder row direction between the upper surface 21B and the intercooler 31 is the aforementioned communication space 20S.

A circular opening 22a to which the common intake pipe 22 is connected is formed near a left end part of the bottom surface 21A of the housing 21. Further, six circular openings 23a to which the six individual intake pipes 23 are respectively connected are formed in an area of the bottom surface 21A excluding the left end part. These circular openings 22a, 23a are respectively referred to as a collecting part intake air inlet 22a and collecting part intake air outlets 23a below.

The common intake pipe 22 includes a vertical common intake pipe 22b extending in a vertical direction, a horizontal common intake pipe 22c extending in a horizontal direction and an intake pipe (not shown) upstream of this horizontal common intake pipe 22c. The vertical common intake pipe 22b is connected to the collecting part intake air inlet 22a. Note that an upstream end of the common intake pipe 22 is connected to a compressor of the supercharger. Upstream ends of the six individual intake pipes 23 are respectively connected to the six collecting part intake air outlets 23a. Downstream ends of the respective individual intake pipes 23 are connected to the intake ports 13 of the respective cylinders 12.

The intercooler 31 functions to cool the intake air supercharged by the supercharger before being fed to the respective cylinders 12. As shown in FIG. 1, the intercooler 31 is of a water cooling plate type and is a laminated structure composed of a plurality of plates 31x having a cooling function and cooling fins 31f sandwiched between these plates 31x. The laminated structure has a rectangular parallelepipedic shape long in the cylinder row direction. As shown in FIG. 3, the plate 31x is a flat plate having a rectangular shape long in the cylinder row direction. A meandering cooling water flow path 31c in which the cooling water flows is densely formed in the plate 31x.

As shown in FIGS. 1, 2 and 7, the plurality of plates 31x are arranged in parallel at specified intervals from each other in an internal space of the housing 21. The cooling fins 31f repeatedly meandering in a front-back direction and extending in the lateral direction are interposed between these plates 31x. Since the cooling fins 31f have such a meandering shape, the air can flow through the laminated structure of the intercooler 31 in the vertical direction. The cooling fin 31f is formed by corrugating a metal plate excellent in heat radiation property and mounted such that tops and bottoms of crest parts and trough parts of the corrugated metal plate are in contact with side surfaces of the plates 31x. The intake air vertically passes through clearances of the crest parts and the trough parts between the plates 31x, thereby being heat-exchanged with the cooling water flowing in the cooling water flow paths 31c to be cooled.

As schematically shown in FIG. 3, a cooling water inlet 31a is formed on a right lower end part of the plate 31x and a cooling water outlet 31b is formed on a left upper end part thereof. The cooling water flow path 31c is formed to vertically meander while connecting these inlet 31a and outlet 31b. Thus, the cooling water flowing in the cooling water flow path 31c gradually flows from the right side to the left side in the intercooler 31 as shown by an arrow in FIG. 3.

As shown in FIGS. 1, 2 and 6, a partition rib 24 extending in the front-back direction of the vehicle is provided to project upwardly near the bottom surface 21A of the housing 21 and on a boundary part between the collecting part intake air inlet 22a and the collecting part intake air outlets 23a. The intercooler 31 includes a first part 31U serving as an upstream passage of the intake air for the communication space 20S in an area to the left of the partition rib 24 (area on one longitudinal end part) and a second part 31D serving as a downstream passage of the intake air for the communication space 20S in an area to the right of the partition rib 24 (remaining area). A downstream end of the common intake pipe 22 (vertical common intake pipe 22b) and upstream ends of the individual intake pipes 23 respectively face the intercooler 31 on the lower surface of the first part 31U and the lower surface of the second part 31D. The partition rib 24 is arranged between the first and second parts 31U and 31D.

Specifically, the first and second parts 31U, 31D are not physically separated parts, but parts obtained by dividing a use area of the intercooler 31 for the common intake pipe 22 and for the individual intake pipes 23 by the partition rib 24. The cooling water flow path 31c of the plate 31x is a single flow path continuous between the first and second parts 31U, 31D.

The intake air (air) is introduced into the housing 21 from the common intake pipe 22 and the introduced intake air is discharged to the individual intake pipes 23 from the housing 21. Specifically, the housing 21 forms such an intake passage that the intake air introduced from the common intake pipe 22 reaches the communication space 20S after passing through the first part 31U of the intercooler 31 from bottom to top and is introduced into the individual intake pipes 23 after passing from the communication space 20S to the second part 31D from top to bottom.

Further, the cooling fins 31f also contribute to the formation of the above intake passage. The cooling fins 31F are shaped to be able to guide the intake air introduced from the common intake pipe 22 to the communication space 20S in the first part 31U and guide the intake air from the communication space 20S to the individual intake pipes 23 in the second part 31D. Specifically, the cooling fins 31F have such a corrugated shape that the crest parts and the trough parts extend in the vertical direction, and the crest parts and the trough parts guide the intake air from bottom to top or from top to bottom. That is, two opposite flows coexist in the same intercooler 31.

A lid member 26 is mounted on the side of the front side surface 21D of the housing 21. The lid member 26 is a member integrally mounted on the front surface (side surface on the side of the second side surface) of the laminated structure of the intercooler 31 through an opening (see FIG. 7) provided on the front side surface 21D and serving as a junction of water supply and discharge paths for the intercooler 31. A cooling water introducing portion 42 connected to the cooling water inlets 31a of the intercooler 31 and a cooling water discharging portion 41 connected to the cooling water outlets 31b of the intercooler 31 are respectively provided on a right lower end part and a left upper end part of the lid member 26. That is, as shown in FIG. 2, the introducing portion 42 and the discharging portion 41 are both arranged on the front side surface 21D, which is a side surface on a side opposite to the side surface (rear side surface 21C) of the housing 21 facing the engine 1. The cooling water is supplied to each plate 31x of the intercooler 31 through the introducing portion 42 and discharged from each plate 31x through the discharging portion 41.

As shown in FIG. 2, the intake air cooling device of this embodiment includes a cooling water circulation device 40. The cooling water circulation device 40 includes a cooling water temperature sensor 43, a cooling water pump 44, a radiator 45 (heat exchanger) and a cooling water circulation path 46. The cooling water circulation path 46 is a flow passage for the cooling water connecting the cooling water discharging portion 41 and the cooling water introducing portion 42. On this cooling water circulation path 46, the cooling water temperature sensor 43 for detecting a temperature of the cooling water, the cooling water pump 44 for circulating the cooling water and the radiator 45 for radiating the heat of the cooling water to cool the cooling water are arranged in this order from an upstream side.

The cooling water circulation device 40 causes the cooling water cooled by the radiator 45 to flow in the first part 31U after causing the cooling water to flow in the second part 31D of the intercooler 31 by the operation of the cooling water pump 44. In that case, the intake air introduced into the housing 21 from the collecting part intake air inlet 22a reaches the communication space 20S after being cooled in the first part 31U of the intercooler 31, and is further cooled in the second part 31D and exits from the housing 21 through the collecting part intake air outlets 23a. Thus, the cooling water having a relatively high temperature flows in the first part 31U and the cooling water having a relatively low temperature flows in the second part 31D. In short, the intake air passing from the left side to the right side in the housing 21 is gradually reduced in temperature toward the right side and the cooling water flowing from the right side to the left side in the intercooler 31 is gradually increased in temperature toward the left side.

Next, functions of this embodiment are described. The intake air cooling device of this embodiment is the intake air cooling device of the engine 1 in which the intercooler 31 is arranged in the intake passage 2 including the intake manifold 20 with the common intake pipe 22 on the upstream side of the intake air flow and the housing 21 forming the space for the collecting part and the individual intake pipes 23 on the downstream side. The communication space 20S extending in the cylinder row direction is formed on the side of the upper surface 21B in the housing 21, whereas the common intake pipe 22 and the individual intake pipes 23 are arranged side by side on the side of the bottom surface 21A of the housing 21. The housing 21 forms such an intake passage that the intake air introduced from the common intake pipe 22 reaches the communication space 20S after passing through the first part 31U of the intercooler 31 and is introduced into the individual intake pipes 23 after passing from the communication space 20S to the second part 31D.

According to this configuration, the first part 31U of the intercooler 31 by the high-temperature cooling water and the second part 31D by the low-temperature cooling water are arranged side by side in the cylinder row direction in the housing 21 of the intake manifold 20. Thus, the intercooler 31 is compactly arranged in the intake passage 2 and interference with the hood and the like in the engine compartment are avoided. Further, since the common intake pipe 22 and the individual intake pipes 23 are arranged on the same surface (bottom surface 21A) of the housing 21, the intake passage 2 itself can be made compact.

Besides, the following intake air flow is generated in the housing 21 of the intake manifold 20. Specifically, the intake air flowing from the upstream side (supercharger) of the intake passage 2 via the common intake pipe 22 flows into the housing 21 through the collecting part intake air inlet 22a below the first part 31U serving as the upstream intake passage of the intercooler 31 (see arrows A in figures). Then, the intake air passes from the side of the bottom surface 21A toward the side of the upper surface 21B through the clearances between the plates 31x of the first part 31U and reaches the communication space 20S. Thereafter, the intake air flows into the second part 31D serving as the downstream intake passage of the intercooler 31 from the side of the upper surface 21B while flowing from the upstream side toward the downstream side in the communication space 20S (see arrows B in figures). The intake air reaches the collecting part intake air outlets 23a (see arrows C in figures) after passing through the clearances between the plates 31x of the second part 31D from the side of the upper surface 21B to the side of the bottom surface 21A. Thereafter, the intake air flows into the intake ports 13 of the respective cylinders 12 via the individual intake pipes 23 (see arrows D in figures).

That is, the intake air flowing into the housing 21 from the collecting part intake air inlet 22a flows from bottom to top in the first part 31U of the intercooler 31 (arrows A) and, at that time, is heat-exchanged with the cooling water flowing in the plates 31x of the first part 31U (cooling water having a relatively high temperature) via the cooling fins 31f. Subsequently, the intake air having flowed from the upstream side to the downstream side of the communication space 20S (arrows B) flows from top to bottom in the second part 31D (arrows C) and, at that time, is heat-exchanged with the cooling water flowing in the plates 31x of the second part 31D (cooling water having a relatively low temperature) via the cooling fins 31f. Thereafter, the intake air flows out from the collecting part intake air outlets 23a and is distributed to the intake ports 13 of the respective cylinders (arrows D).

As just described, since the intake air is first cooled in the first part 31U of the intercooler 31 and then cooled in the second part 31D, it is efficiently cooled in two stages and intake air cooling efficiency is enhanced. In addition, since the intake air flows in a U-turn manner in the housing 21 (arrows A, B, C), a reduction in intake air resistance and intake air distribution into the respective cylinders 12 (uniform distribution performance) are enhanced. In that case, the partition rib 24 prevents the intake air introduced into the collecting part space of the housing 21 from the collecting part intake air inlet 22a from leaking to the collecting part intake air outlets 23a (individual intake pipes 23) without contacting the intercooler 31 and exiting from the housing 21.

The intercooler 31 is the laminated structure composed of the plurality of water cooling system plates 31x and the cooling fins 31f sandwiched between these plates 31x. The cooling fins 31f are shaped to be able to guide the intake air introduced from the common intake pipe 22 to the communication space 20S in the first part 31U and guide the intake air from the communication space 20S to the individual intake pipes 23 in the second part 31D. That is, since the corrugated cooling fins 31f including the crest parts and the trough parts extending in the vertical direction are interposed between the pair of plates 31x, the intake air can vertically pass through the intercooler 31 without being dispersed in the cylinder row direction in the intercooler 31. Thus, the aforementioned U-turn flow of the intake air can be satisfactorily formed.

The first part 31U is arranged in the area near the left end of the intercooler 31 and the second part 31D is arranged in the remaining area of the intercooler 31. Such an arrangement is advantageous in forming the aforementioned U-turn flow of the intake air and suitable for the multi-cylinder engine including the plurality of collecting part intake air outlets 23a that need to be arranged in the cylinder row direction.

The introducing portion 42 and the discharging portion 41 of introducing and discharging the cooling water into and from the intercooler 31 are mounted on the intercooler 31 through the front side surface 21D of the housing 21. The front side surface 21D is the side surface on the side opposite to the side surface (rear side surface 21C) of the housing 21 facing the engine 1. This enables the introducing portion 42 and the discharging portion 41 to be distanced from the engine 1 that gets hot and facilitates the routing of pipes to be connected to the introducing portion 42 and the discharging portion 41. Furthermore, a layout for bringing the intake manifold 20 closer to the engine 1 is possible and an intake system can be made compact.

Further, the lid member 26 is integrally mounted on the side surface of the intercooler 31 on the side of the front side surface 21D. This enables an operation mode of inserting the intercooler 31 having the lid member 26 assembled therewith into the housing 21 through the front side surface 21D, which is the side surface on the side opposite to the engine, to be adopted in an operation of assembling the intercooler 31 into the housing. Thus, assembling operability of the intercooler 31 can be improved.

The intake air cooling device of this embodiment includes the cooling water circulation device 40 with the pump 44 for circulating the cooling water and the radiator 45 for cooling the cooling water. The cooling water circulation device 40 causes the cooling water cooled by the radiator 45 to flow in the first part 31U after causing it to flow in the second part 31D of the intercooler 31. In this way, the first part 31U in which the cooling water heat-exchanged with the intake air flow having a high temperature and having a relatively high temperature flows and the second part 31D in which the cooling water having a low temperature flows can be configured by the single cooling water circulation device 40 having a simple configuration.

The intercooler 31 includes the plates 31x each internally provided with the flow path 31c in which the cooling water flows, and the flow paths 31c are flow paths continuous between the first and second parts 31U, 31D. In this way, the first and second parts 31U, 31D are more compactly arranged in the housing 21 of the intake manifold 20.

### Second Embodiment

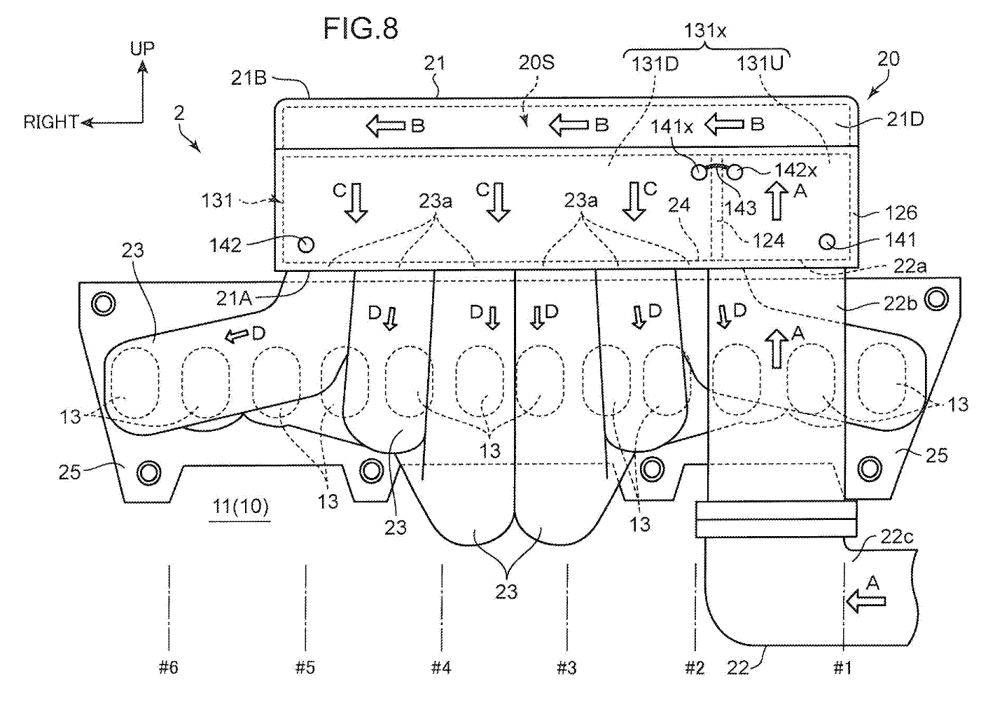

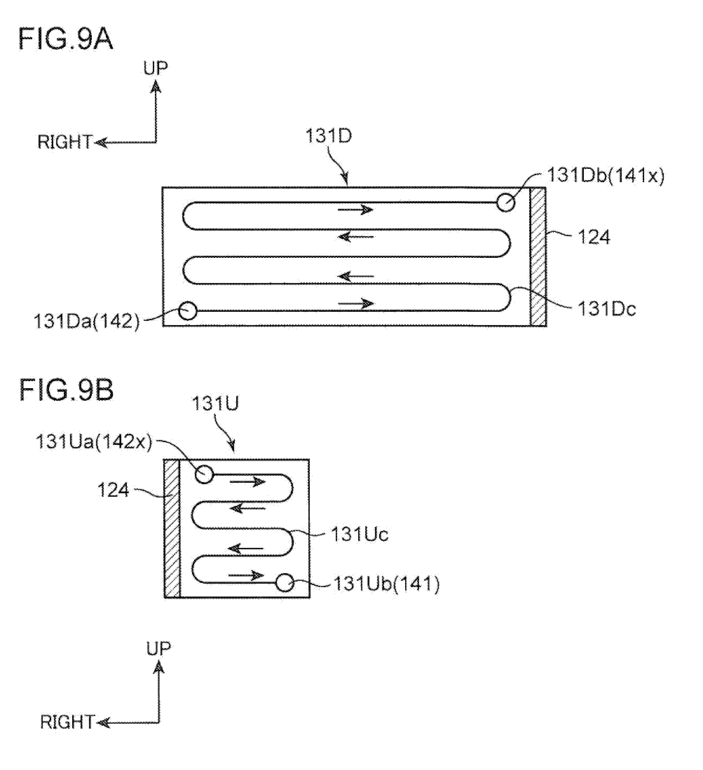

FIG. 8 is a front view of an intake air cooling device of an engine according to a second embodiment of the present invention. FIGS. 9A and 9B are respectively views of single bodies of a downstream plate 131D and an upstream plate 131U of an intercooler used in the second embodiment. Same or similar constituent elements as those of the first embodiment are denoted by the same reference signs and only characteristic parts of the second embodiment are described.

In an intercooler 131 of the second embodiment, plates 131x each composed of the upstream plate 131U (first part) and the downstream plate 131D (second part) are used. The upstream and downstream plates 131U, 131D are not integrated and separate from each other. The downstream plate 131D is formed with a cooling water inlet 131Da on a right lower end part thereof and a cooling water output 131Db on a left upper end part thereof. A cooling water flow path 131Dc is formed to laterally meander while connecting the inlet 131Da and the outlet 131Db and causes cooling water to circulate from a downstream side toward an upstream side of an intake air flow. On the other hand, the upstream plate 131U is formed with a cooling water inlet 131Ua on a right upper end part thereof and a cooling water outlet 131Ub on a left lower end part thereof. The cooling water flow path 131Uc is formed to laterally meander while connecting the inlet 131Ua and the outlet 131Ub and causes the cooling water to circulate from a downstream side toward an upstream side of an intake air flow.

As shown in FIG. 8, a partition wall 124 extending in a front-back direction is provided to stand on a boundary part between a collecting part intake air inlet 22a and collecting part intake air outlets 23a (between the first and second parts) on a bottom surface 21B of a housing 21. The upstream plate 131U is arranged in a part to the left of the partition wall 124 and located above the collecting part intake air inlet 22a while being housed in the housing 21. Further, the downstream plate 131D is arranged in a part to the right of the partition wall 124 and located above the collecting part intake air outlets 23a.

The partition wall 124 is arranged between the upstream plates 131U and the downstream plates 131D and functions to hinder the flow of the intake air in a cylinder row direction (longitudinal direction) in the intercooler 131. Also in this embodiment, corrugated cooling fins 31f as shown in FIG. 1 are arranged between the plates 131U, 131D. In the case of using, for example, cooling fins with louvers having high heat exchange efficiency as these cooling fins 131f, the intake air can flow in the cylinder row direction through the louvers in the intercooler 131. Accordingly, the intake air introduced into the housing 21 from the collecting part intake air inlet 22a may possibly leak to the collecting part intake air outlets 23a before reaching a communication space 20S. The partition wall 124 functions to prevent such leakage of the intake air.

A lid member 126 is mounted on a front side surface 21D of the housing 21. A cooling water introducing portion 142 connected to the cooling water inlets 131Da of the downstream plates 131D and a cooling water discharging portion 141 connected to the cooling water outlets 131Ub of the upstream plates 131U are respectively provided on a right lower end part and a left upper end part of the lid member 126. In addition, a cooling water intermediate discharging portion 141x connected to the cooling water outlets 131Db of the downstream plates 131D is formed on an upper part of the lid member 126 to the right of the partition wall 124 and a cooling water intermediate introducing portion 142x connected to the cooling water inlets 131Ua of the upstream plates 131U is formed on an upper part of the lid member 126 to the left of the partition wall 124. The cooling water intermediate discharging portion 141x and the cooling water intermediate introducing portion 142x are connected by a cooling water intermediate connection pipe 143.

A cooling water circulation device similar to that of the first embodiment is usable. Specifically, a cooling water circulation path 46 connecting the cooling water discharging portion 141 and the cooling water introducing portion 142 is provided, and a cooling water temperature sensor 43 for detecting a temperature of the cooling water, a cooling water pump 44 for circulating the cooling water and a radiator (heat exchanger) 45 for radiating the heat of the cooling water to cool the cooling water are arranged in this order from an upstream side on the cooling water circulation path 46. In this way, the cooling water circulation device 40 is constructed which causes the cooling water cooled by the radiator 45 to flow in the upstream plates 131U after causing the cooling water to flow in the downstream plates 131D.

### Third Embodiment

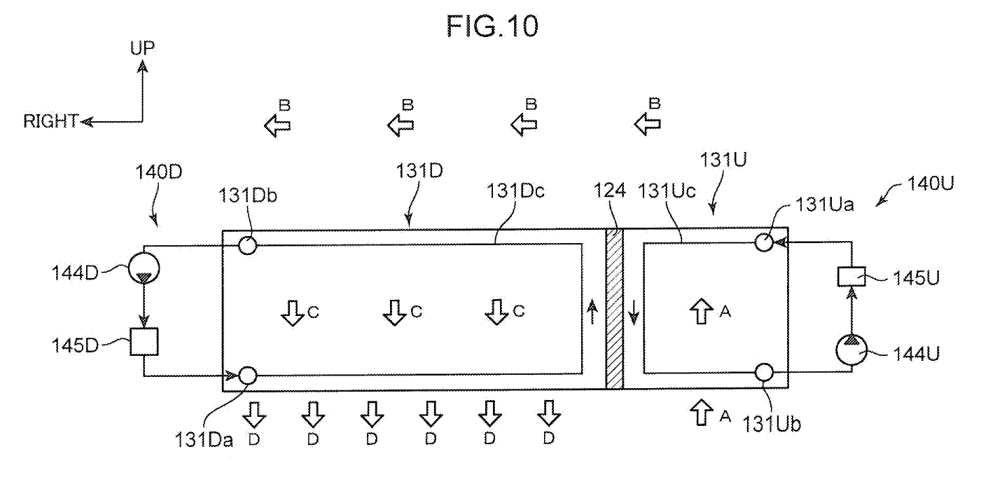

FIG. 10 is a configuration diagram of downstream and upstream cooling water circulation devices of a third embodiment. Same or similar constituent elements as those of the first and second embodiments are denoted by the same reference signs and only characteristic parts of the third embodiment are described.

In the third embodiment, two cooling water circulation devices for upstream plates 131U and for downstream plates 131D are used.

Specifically, an upstream cooling water pump 144U for circulating cooling water and an upstream radiator 145U for radiating the heat of the cooling water to cool the cooling water are arranged in this order from an upstream side on a cooling water circulation path connecting cooling water outlets 131Ub and cooling water inlets 131Ua of the upstream plates 131U. In this way, an upstream cooling water circulation device 140U is constructed which causes the cooling water cooled by the radiator 145U to flow in the upstream plates 131U.

Similarly, a downstream cooling water pump 144D for circulating the cooling water and a downstream radiator 145D for radiating the heat of the cooling water to cool the cooling water are arranged in this order from an upstream side on a cooling water circulation path connecting cooling water outlets 131Db and cooling water inlets 131Da of the upstream plates 131D. In this way, a downstream cooling water circulation device 140D is constructed which causes the cooling water cooled by the radiator 145D to flow in the downstream plates 131D.

The upstream cooling water circulation device 140U is desirably configured such that the cooling water for cooling an engine is circulated as the cooling water that flows in the upstream plates 131U. This enables the circulation of the cooling water having a relatively high temperature to keep the engine at a suitable temperature. On the other hand, the downstream cooling water circulation device 140D can cool and adjust the cooling water in the downstream radiator 145D and cause the cooling water having a low temperature to circulate.

Note that although the cooling water is circulated in the upstream plates (first part) and the downstream plates (second part) in each of the above embodiments, the intake air may be cooled by introducing cooling air instead of this. Further, each plate may be configured to use coolant and cooling air. Furthermore, although the upstream plates are set at a higher cooling temperature and the downstream plates are set at a lower cooling temperature to enhance cooling efficiency, there is no limitation to this. The cooling temperatures of the both plates by the coolant or cooling air may be set at substantially equal cooling temperatures. At that time, it is preferable to set relatively low cooling temperatures.

Although the present invention has been described in detail by way of the embodiments, the present invention is not limited to the above embodiments and various changes such as the shapes and the numbers of the constituent elements can be made without departing from the sprit and scope of the appended claims.

Note that the intake air cooling devices having the following configurations are disclosed in the specific embodiments described above.

An intake air cooling device according to the present disclosure is an intake air cooling device of an engine in which an intercooler is arranged in an intake passage including a common intake pipe on an upstream side and individual intake pipes on a downstream side and includes a collecting part of a predetermined capacity provided in an intake manifold and extending in a cylinder row direction, a first intercooler and a second intercooler arranged adjacent to each other in the cylinder row direction in the collecting part, a collecting part intake air inlet provided below the first intercooler of the collecting part and connected to an upstream intake passage via the common intake pipe and collecting part intake air outlets provided below the second intercooler of the collecting part and connected to intake ports of respective cylinders via the individual intake pipes. Note that “upstream” and “downstream” relate to the flow of fluid flowing there.

According to the above intake air cooling device, the first and second intercoolers are arranged side by side in the cylinder row direction, which is a longitudinal direction of the collecting part, in the collecting part of the intake manifold. Thus, the both intercoolers are compactly arranged in the intake passage and interference with a hood in an engine compartment and the like are avoided.

Besides, the following intake air flow is generated in the collecting part of the intake manifold. Specifically, the intake air flowing from the upstream intake passage via the common intake pipe flows into the collecting part via the collecting part intake air inlet below the first intercooler and flows from an upstream side to a downstream side in the collecting part. Thereafter, the intake air flows out from a downstream collecting part via the collecting part intake air outlets below the second intercooler and flows into the intake ports of the respective cylinders via the individual intake pipes. That is, the intake air flowing into an upstream collecting part from the collecting part intake air inlet flows from bottom to top in the first intercooler and is, at that time, heat-exchanged with the first intercooler. Subsequently, the intake air having flowed from an upper part of the upstream collecting part to an upper part of the downstream collecting part flows from top to bottom in the second intercooler and is, at that time, heat-exchanged with the second intercooler. Thereafter, the intake air flows out from the collecting part intake air outlets located in the downstream collecting part and is distributed to the intake ports of the respective cylinders.

As just described, the intake air is first cooled by the first intercooler using, for example, high-temperature coolant and then cooled by the second intercooler using, for example, low-temperature coolant. Thus, the intake air is efficiently cooled in two stages and intake air cooling efficiency is enhanced. In addition, since the intake air flows in a U-turn manner in the collecting part, a reduction in intake air resistance and intake air distribution into the respective cylinders (uniform distribution performance) are enhanced.

The above intake air cooling device preferably further includes a coolant circulation device having a pump for circulating the coolant and a heat exchanger for cooling the coolant and configured to cause the coolant cooled by the heat exchanger to flow in the first intercooler after causing the coolant to flow in the second intercooler.

According to this configuration, the first intercooler in which the relatively high-temperature coolant by being heat-exchanged with the intake air having a high temperature flows and the second intercooler in which the low-temperature coolant flows can be configured by the single coolant circulation device having a simple configuration.

In the above intake air cooling device, the first and second intercoolers are preferably integrated into a single intercooler by connecting flow paths for the coolant to each other.

According to this configuration, the first intercooler on the upstream side and the second intercooler on the downstream side are more compactly arranged in the collecting part of the intake manifold.

According to the present invention as described above, an intake air cooling device of an engine is provided which can enhance intake air cooling efficiency and enhance a reduction in intake air resistance and intake air distribution performance while an intercooler is compactly arranged.

What is claimed is:

1. An intake air cooling device of a multi-cylinder internal combustion engine, comprising:
an intake manifold including a housing defining a space extending in a cylinder row direction of multiple cylinders and a plurality of individual intake pipes projecting from the housing and communicating with the respective cylinders;
a water cooling intercooler housed in the housing; and
a common intake pipe coupled to the housing and configured to introduce air into the housing;
wherein:
the housing has a first surface and a second surface facing each other;
the water cooling intercooler is housed in a space near the first surface in the housing and a communication space extending in the cylinder row direction is formed between the second surface and the water cooling intercooler;
the common intake pipe and the individual intake pipes are arranged side by side on the side of the first surface of the housing;
the water cooling intercooler includes a first part facing the common intake pipe and a second part facing the individual intake pipes; and
the housing forms such an intake passage that the air introduced from the common intake pipe reaches the communication space after passing through the first part and is introduced into the individual intake pipes after passing from the communication space to the second part.

2. An intake air cooling device according to claim 1, wherein:
the water cooling intercooler is a laminated structure composed of a plurality of plates each including a flow path inside, the cooling water being caused to flow in the flow paths, and a cooling fin sandwiched between the plates; and
the cooling fin is shaped to be able to guide the air introduced from the common intake pipe to the communication space in the first part and guide the air from the communication space to the individual intake pipes in the second part.

3. An intake air cooling device according to claim 2, wherein:
the laminated structure of the water cooling intercooler has a rectangular parallelepipedic shape whose longitudinal direction is aligned with the cylinder row direction; and
the first part is an area on one end part of the water cooling intercooler in the longitudinal direction and the second part is a remaining area of the water cooling intercooler other than the one end part.

4. An intake air cooling device according to claim 3, further comprising:
an introducing portion configured to supply the cooling water to the water cooling intercooler and a discharging portion configured to discharge the cooling water from the water cooling intercooler, wherein:
the first surface is a bottom surface of the housing and the second surface is an upper surface of the housing;
the housing has a first side surface facing the multi-cylinder internal combustion engine and a second side surface on a side opposite to the first side surface; and
the introducing portion and the discharging portion are mounted on the water cooling intercooler through the second side surface.

5. An intake air cooling device according to claim 4, further comprising:
a rib arranged between the first part and the second part near the first side surface of the housing and configured to hinder the leakage of the air introduced from the common intake pipe to the individual intake pipes.

6. An intake air cooling device according to claim 4, further comprising:
a lid member including the introducing portion and the discharging portion, wherein:
the lid member is integrally mounted on a side surface of the water cooling intercooler on the side of the second side surface.

7. An intake air cooling device according to claim 3, further comprising:
a partition wall arranged between the first part and the second part and configured to hinder the flow of the air in the longitudinal direction in the water cooling intercooler.

8. An intake air cooling device according to claim 1, further comprising:
a coolant circulation device including a pump for circulating the cooling water and a heat exchanger for cooling the cooling water, wherein:
the coolant circulation device causes the cooling water cooled by the heat-exchanger to flow in the first part after causing the cooling water to flow in the second part of the water cooling intercooler.

9. An intake air cooling device according to claim 1, wherein:
the water cooling intercooler includes a plate with a flow path inside, the cooling water being caused to flow in the flow path; and
the flow path is a flow path continuous between the first part and the second part.
